(19) United States
(12) Patent Application Publication
(10) Pub. No.: US 2016/0172952 A1
(43) Pub. Date: Jun. 16, 2016

(54) STEPPING MOTOR AND STATOR THEREOF

(71) Applicant: Wellgain Motion Tech Company Limited, Kowloon (HK)

(72) Inventor: Man Fai Cheung, Kowloon (HK)

(21) Appl. No.: 14/958,630

(22) Filed: Dec. 3, 2015

(30) Foreign Application Priority Data
Dec. 12, 2014 (CN) 201410773349.9

(51) Int. Cl. H02K 37/16; H02K 1/14

(52) U.S. Cl. CPC H02K 37/16; H02K 1/143

(57) ABSTRACT

A stator of a stepping motor comprises two magnetic field closed loops. Each magnetic field closed loop comprises a body as well as a main driving pole and an auxiliary driving pole. The main driving pole and the auxiliary driving pole are configured to assemble a coil. The two main driving poles and the two auxiliary driving poles cooperatively enclose to form a receiving hole for receiving a rotator, and an open space is formed between the two main driving poles and/or the two auxiliary driving poles.

### RELATED APPLICATIONS

This application claims priority under 35 U.S.C. §119 to Chinese Patent Application No. 201410773349.9, filed Dec. 12, 2014. The entire teachings of the above application are incorporated herein by reference.

### FIELD OF THE INVENTION

The present disclosure relates to a technique field of instrument drive, and more particularly relates to a stepping motor and a stator thereof.

### BACKGROUND OF THE INVENTION

In various instrument devices and equipments, various types of stepping motors are usually required to provide power; especially in electronic products such as automobile instruments, watches and so on, higher precision stepping motor are required.

As shown in FIG. 1, a conventional stepping motor comprises a first stator plate 11, a second stator plate 12, and a rotator 13. The first stator plate 11 and the second stator plate 12 are partially laminated. Two end faces of the first stator plate 11 are a first end face 16 and a second end face 18 respectively. Two end faces of the second stator plate 12 are a third end face 17 and a fourth end face 19 respectively. The first end face 16, the second end face 18, the third end face 17, and the fourth end face 19 receive the rotator 13 clockwise. Both the first stator plate 11 and the second stator plate 12 comprise a coil. Further, there are two magnetic poles having dissimilar magnetism in the rotator 13.

When the coils of the first stator plate 11 and the second stator plate 12 are powered, a magnetic field can be generated at the first end face 16, the second end face 18, the third end face 17, and the fourth end face 19 respectively. The magnetic field can generate a magnetic moment for the magnetic poles of the rotator 13, promoting rotation of the rotator 13. Particularly, when the current directions of the coils of the first stator plate 11 and the second stator plate 12 changes alternately, generated alternating magnetic field can promote rotation of the rotator continuously.

However, due to structure of the first stator plate 11 and the second stator plate 12 described above, assembly of the coil thereon is not convenient, and because the first stator plate 11 and the second stator plate 12 are partially laminated, assembly of them is difficult, and when assembling, it is easy to cause bias of angle.

### SUMMARY OF THE INVENTION

On the basis of this, it is necessary to provide a stepping motor and a stator thereof which is simple and can facilitate assembly of the coil.

A stator of a stepping motor includes: a first magnetic field closed loop comprising a first body, a first main driving pole, and a first auxiliary driving pole, wherein the first main driving pole and the first auxiliary driving pole are spaced on the same side of the first body, the first main driving pole and the first auxiliary driving pole are configured to assemble a coil of the stepping motor; and a second magnetic field closed loop comprising a second body, a second main driving pole and a second auxiliary driving pole, wherein the second main driving pole and the second auxiliary driving pole are spaced on the same side of the second body, the second main driving pole and the second auxiliary driving pole are configured to assemble the coil of the stepping motor; wherein the first main driving pole is adjacent to the second main driving pole, and the first main driving pole and the second main driving pole are spaced, the first auxiliary driving pole and the second auxiliary driving pole are spaced; the first main driving pole, the first auxiliary driving pole, the second main driving pole, and the second auxiliary driving pole cooperatively enclose to form a receiving hole for receiving a rotator of the stepping motor, and an open space is formed between one end of the first body adjacent to the first auxiliary driving pole and one end of the second body adjacent to the second auxiliary driving pole and/or between one end of the first body adjacent to the first main driving pole and one end of the second body adjacent to the second main driving pole.

A stepping motor includes: the stator described above; and the rotator received in the receiving hole, and respectively spaced from the first main driving pole, the first auxiliary driving pole, the second main driving pole, and the second auxiliary driving pole.

The arrangement of the open space enables the stator described above to have a sufficient assembly space, and the coil can be inserted into the first main driving pole (or the first auxiliary driving pole) and the second main driving pole (or the second auxiliary driving pole) directly from the open space, which enables very simple, convenient operation and high productivity. Furthermore, the stator described above has a simple shape and can be produced easily, facilitating control of quality. When assembling the stator described above, it only needs to properly adjust the arrangement and position of the first magnetic field closed loop and the second magnetic field closed loop, thus assembly thereof is very simple and does not cause bias of angle easily. Furthermore, due to the existence of the open space, the stator described above takes up little room and consumes few production materials, which enables the stator described above to suit precision devices and have a relative lower cost.

### BRIEF DESCRIPTION OF THE DRAWINGS

These and other features of the present invention will become readily apparent upon further review of the following specification and drawings. In the drawings, like reference numerals designate corresponding parts throughout the views. Moreover, components in the drawings are not necessarily drawn to scale, the emphasis instead being placed upon clearly illustrating the principles of the present disclosure.

FIG. 1 is a schematic diagram of a conventional stepping motor;

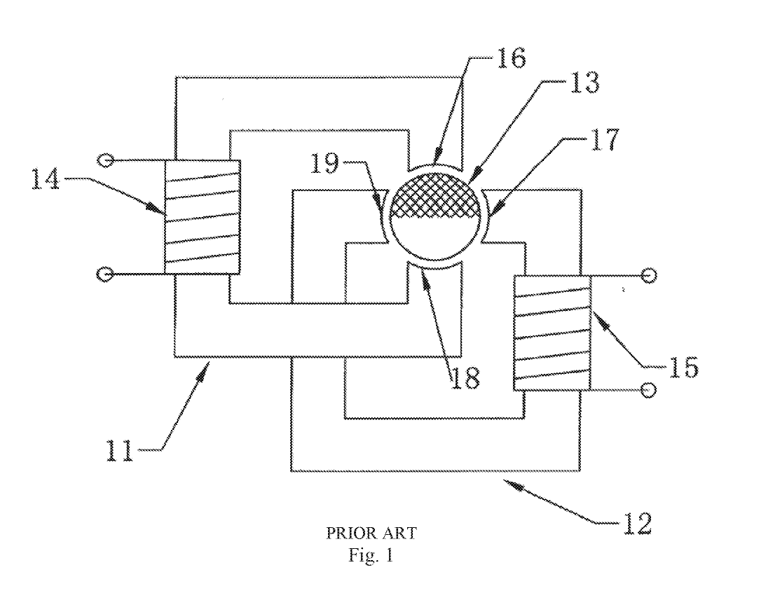

FIG. 2 is a schematic diagram of a stepping motor in accordance with an embodiment;

FIG. 3 is a schematic diagram of an effective drive area of the stepping motor in FIG. 2;

FIG. 4 is a working state diagram of the stepping motor in FIG. 2;

FIG. 5 is another working state diagram of the stepping motor in FIG. 2;

FIG. 6 is another working state diagram of the stepping motor in FIG. 2; and

FIG. 7 is another working state diagram of the stepping motor in FIG. 2.

### DETAILED DESCRIPTION OF THE EMBODIMENTS

For facilitating understanding of the present invention, the present invention will be described more fully hereinafter with reference to the related accompanying drawings. The better embodiments are given in the accompanying drawings. The invention may, however, be embodied in many different forms and should not be construed as limited to the embodiments set forth herein. Rather, the object for providing these embodiments is to understand this disclosure of the invention thoroughly and completely.

It needs to explain that when an element is referred to as being “fixed” to another element, it can be directly on the other element or intervening elements may be present. When an element is referred to as being “connected” to another element, it can be directly connected to the other element or intervening elements may be present at the same time.

Unless otherwise defined, all terms (including technical and scientific terms) used herein have the same meaning as commonly understood by one of ordinary skill in the art to which this invention belongs. Herein, terms used in the specification of the invention aim at describing the specific embodiments without limiting the invention. Terms “ and/or ” used herein comprise any and all combinations of one or more related items listed.

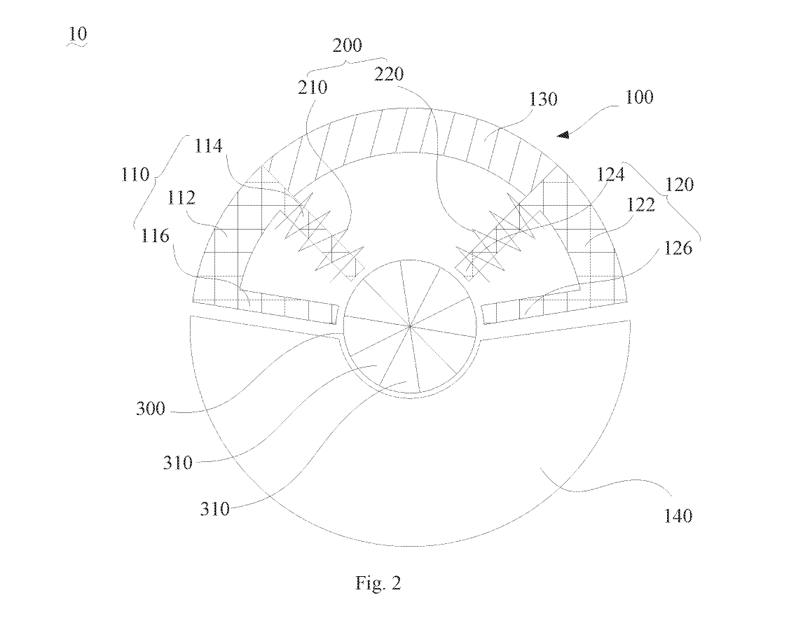

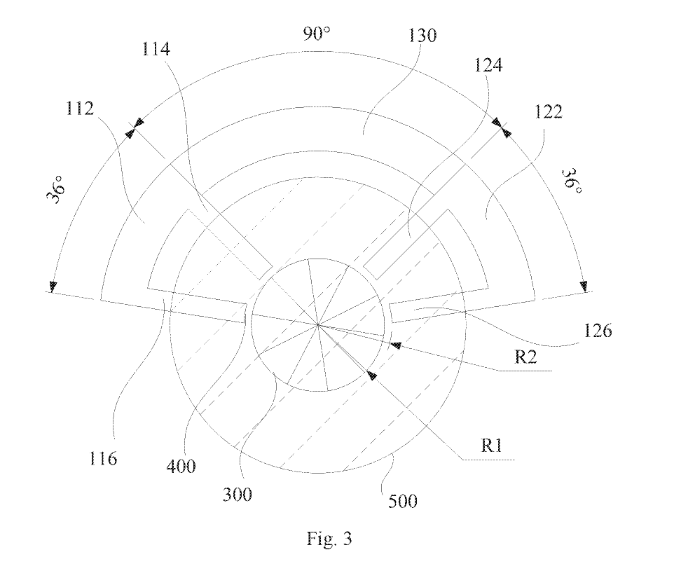

As shown in FIG. 2 and FIG. 3, a stepping motor 10 of an embodiment comprises a stator 100, a coil 200, and a rotator 300.

The stator 100 comprises a first magnetic field closed loop 110, a second magnetic field closed loop 120, and a connector 130.

The first magnetic field closed loop 110 comprises a main body 112, a first main driving pole 114, and a first auxiliary driving pole 116. The first main driving pole 114 and the first auxiliary driving pole 116 are spaced on the same side of the main body 112. The first main driving pole 114 and the first auxiliary driving pole 116 are configured to assemble the coil 200 of the stepping motor 10. Further, in the illustrated embodiment, the main body 112, the first main driving pole 114, and the first auxiliary driving pole 116 are integrally formed.

The second magnetic field closed loop 120 comprises a second main body 122, a second main driving pole 124, and a second auxiliary driving pole 126. The second main driving pole 124 and the second auxiliary driving pole 126 are spaced on the same side of the second main body 122. The second main driving pole 124 and the second auxiliary driving pole 126 are configured to assemble the coil 200 of the stepping motor 10. Further, in the embodiment, the second main body 122, the second main driving pole 124, and the second auxiliary driving pole 126 are integrally formed.

The first main driving pole 114 is positioned adjacent to the second main driving pole 124, and the first main driving pole 114 and the second main driving pole 124 are spaced. The first auxiliary driving pole 116 and the second auxiliary driving pole 126 are spaced. The first main driving pole 114, the first auxiliary driving pole 116, the second main driving pole 124, and the second auxiliary driving pole 126 cooperatively enclose to form a receiving hole (not shown) for receiving the rotator 300 of the stepping motor 10. An open space 140 is formed between one end of the first body 112 adjacent to the first auxiliary driving pole 116 and one end of the second body 122 adjacent to the second auxiliary driving pole 126 and/or between one end of the first body 112 adjacent to the first main driving pole 114 and one end of the second body 122 adjacent to the second main driving pole 124.

In the embodiment, the spacing distance between one end of the first main driving pole 114 away from the first main body 112 and one end of the first auxiliary driving pole 116 away from the first main body 112 decreases gradually, in other words, if the free ends of the first main driving pole 114 and the first auxiliary driving pole 116 continue to extend in a direction away from the first main body 112, then they will intersect to form an angle. The spacing distance between one end of the second main driving pole 214 away from the second main body 212 and one end of the second auxiliary driving pole 216 away from the second main body 212 decreases gradually, that is, if the free ends of the second main driving pole 214 and the second auxiliary driving pole 216 continue to extend in a direction away from the second main body 212, then they will intersect to form an angle.

The arrangement of the open space 140 enables the stator 100 described above to have a sufficient assembly space, and the coil 200 can be inserted into the first main driving pole 114 (or the first auxiliary driving pole 116) and the second main driving pole 124 (or the second auxiliary driving pole 126) directly from the open space 140, which enables a very simple, convenient operation and high productivity. Furthermore, the stator 100 described above has a simple shape and can be produced easily, facilitating control of quality. When assembling the stator 100 described above, it only needs to properly adjust the arrangement and position of the first magnetic field closed loop 110 and the second magnetic field closed loop 120, thus assembly thereof is very simple and does not cause bias of angle easily. Furthermore, due to the existence of the open space 140, the stator 100 described above takes up little room and consumes few production materials, which enables the stator 100 described above to suit precision devices and have a relative lower cost.

Moreover, the first magnetic field closed loop 110 and the second magnetic field closed loop 120 are coordinated with the open space 140, which makes the contour design of the stator 100 very compact, further facilitating use of the stator 100 in a narrow space or environment.

In the embodiment, the first magnetic field closed loop 110 is connected to the second magnetic field closed loop 120 via the connector 130, that is, the first magnetic field closed loop 110 and the second magnetic field closed loop 120 are spaced without overlapped part. Both ends of the connector 130 are respectively connected with one end of the first body 112 adjacent to the first main driving pole 114 and one end of the second body 212 adjacent to the second main driving pole 214, so that an open space 140 is formed between one end of the first body 112 adjacent to the first auxiliary driving pole 116 and one end of the second body 122 adjacent to the second auxiliary driving pole 126, whereas the open space 140 is not formed between the one end of the first body 112 adjacent to the first main driving pole 114 and the one end of the second body 212 adjacent to the second main driving pole 214.

It can be understood that, in alternative embodiments, the first magnetic field closed loop 110 can be also connected to the second magnetic field closed loop 120 in such a manner that the one end of the first body 112 adjacent to the first main driving pole 114 is connected directly to the one end of the second body 212 adjacent to the second main driving pole 214, then the connector 130 can be omitted.

In other embodiments, the first magnetic field closed loop 110 may not be connected with the second magnetic field closed loop 120 either, and the one end of the first body 112 adjacent to the first main driving pole 114 and the one end of the second body 212 adjacent to the second main driving pole 214 are spaced, that is to say, the connector 130 can be omitted. At this time, an open space 140 is formed both between one end of the first body 112 adjacent to the first auxiliary driving pole 116 and one end of the second body 122 adjacent to the second auxiliary driving pole 126 and between the one end of the first body 112 adjacent to the first main driving pole 114 and the one end of the second body 212 adjacent to the second main driving pole 214.

In the embodiment, the first magnetic field closed loop 110, the second magnetic field closed loop 120, and the connector 130 are three independent elements. It can be understood that in other embodiments the first magnetic field closed loop 110, the second magnetic field closed loop 120, and the connector 130 are integrally formed.

Further, in the embodiment, the first main driving pole 114 and the first auxiliary driving pole 116 are respectively located at both ends of the first main body 112. The second main driving pole 124 and the second auxiliary driving pole 126 are respectively located at both ends of the second main body 122, and the first main driving pole 114 is located between the first main body 112 and the connector 130. The second main driving pole 124 is located between the second main body 122 and the connector.

Further, in the embodiment, the first main driving pole 114 and the second main driving pole 124 are vertically disposed; an angle formed by one side of the first main driving pole 114 away from the first auxiliary driving pole 116 and one side of the first auxiliary driving pole 116 away from the first main driving pole 114 is 36°; an angle formed by one side of the second main driving pole 124 away from the second auxiliary driving pole 126 and one side of the second auxiliary driving pole 126 away from the second main driving pole 124 is 36°, thus ensuring the open space 140 of the stator 100 described above has an appropriate size, and enabling the stator 100 to promote rotation of the rotator 300 better at the same time.

Further, in the embodiment, the shapes and sizes (dimension) of the first main driving pole 114, the first auxiliary driving pole 116, the second main driving pole 124, and the second auxiliary driving pole 126 are the same. When the coil 200 is not powered, the first main driving pole 114, the first auxiliary driving pole 116, the second main driving pole 124, and the second auxiliary driving pole 126 attract the rotator 300 (having magnetism). Because the center of the rotator 300 has been fixed, the gravitation is transformed into the torque force. Because the shapes and sizes of the first main driving pole 114, the first auxiliary driving pole 116, the second main driving pole 124, and the second auxiliary driving pole 126 are the same, the torque forces subjected to the rotator 300 cancel out each other, that is to say, the resultant force suffered by the rotator 300 is zero, and then the rotator 300 is in a free state. When powered, the coil 200 generates a drive of the magnetic field and then the rotator 300 rotates. The rotator 300 is driven just as only by a drive gravitation of the magnetic field, and rotates very smoothly.

Further, in the embodiment, the shapes and sizes of the first main body 112 and the second main body 122 are the same, that is, the shapes and sizes of the first magnetic field closed loop 110 and the second magnetic field closed loop 120 are the same.

There are two coils 200, which are respectively a first coil 210 and a second coil 220. The first coil 210 is provided on the first main driving pole 114 or the first auxiliary driving pole 116, and the second coil 220 is provided on the second main driving pole 124 or the second auxiliary driving pole 126. In the embodiment, the first coil 210 and the second coil 220 are provided on the first main driving pole 114 and the second main driving pole 124 respectively. Because the first coil 210 and the second coil 220 are located inside of the stator 100, the stepping motor 10 described above has a smaller volume.

The rotator 300 has magnetism and several magnetic poles 310. The number of the magnetic poles 210 is an even number greater than 2, that is, the rotator 300 comprises at least four magnetic poles 310. The number of the magnetic poles 310 decides the stepping angle of the stepping motor 10. The stepping angle is the quotient of 180° divided by the number of the magnetic poles 310. The stepping precision can be improved continually by increasing the number of the magnetic poles 310, while the cost has to be considered. In the embodiment, preferably, the number of the magnetic poles 310 is 10.

The rotator 300 is provided in the receiving hole and spaced from the first main driving pole 114, the first auxiliary driving pole 116, the second main driving pole 124, and the second auxiliary driving pole 126 respectively.

Further, in the embodiment, one end of the first coil 210 away from the first main body faces directly and comes adjacent to the rotator 300. One end of the second coil 220 away from the second main body 212 faces directly and comes adjacent to the rotator 300.

Further, in the embodiment, the end faces of one ends of the first main driving pole 114, the first auxiliary driving pole 116, the second main driving pole 124, and the second auxiliary driving pole 126 adjacent to the rotator 300 present the arc, and the end faces of one ends of the first main driving pole 114, the first auxiliary driving pole 116, the second main driving pole 124, and the second auxiliary driving pole 126 adjacent to the rotator 300 are different parts of a first circle 400. A center of the first circle 400 coincides with a center of the rotator 300.

The radius of the rotator 300 is R1, the radius of the first circle 400 is R2, a distance between the first circle 400 and the rotator 300 is d, and d is a difference between R2 and R1. A space outward from an outer wall of the rotator 300 is a functional space (not shown). The areas on which the functional space and the rotator 300 are located constitute an effective drive area 500 together. A distance between a boundary of the functional space away from the rotator 300 and the outer wall of the rotator 300 is at least 5 d. Further, in the embodiment, the distance between a boundary of the functional space away from the rotator 300 and the outer wall of the rotator 300 is 5 d-10 d.

The boundary of the functional space can be any shape. In the embodiment, preferably, the boundary of the functional space is round.

Further, in the embodiment, the distance between a boundary of the functional space away from the rotator 300 and the outer wall of the rotator 300 is 5 d, enabling the stator 100 to have a maximum driving power.

Further, in the embodiment, one ends of the first main driving pole 114, the first auxiliary driving pole 116, the second main driving pole 124, and the second auxiliary driving pole 126 away from the rotator 300 are located outside of the effective drive area 500, and the connector 130 is located outside of the effective drive area 500. Further, except the first main driving pole 114, the first auxiliary driving pole 116, the second main driving pole 124, the second auxiliary driving pole 126, and the rotator 300, any other soft or hard ferromagnets are not placed in the effective drive area 500. If other soft or hard ferromagnets are not placed in the effective drive area 500, the other soft or hard ferromagnets and the rotator 300 will attract each other, influencing smooth rotation of the rotator 300. Whereas, if other soft or hard ferromagnets are not placed out of the effective drive area 500, the first magnetic field closed loop 110 and the second magnetic field closed loop 120 will be rarely influenced (this influence can be ignored), not influencing smooth rotation of the rotator 300.

The following is the detailed description, wherein the rotator is a magnet of ten poles.

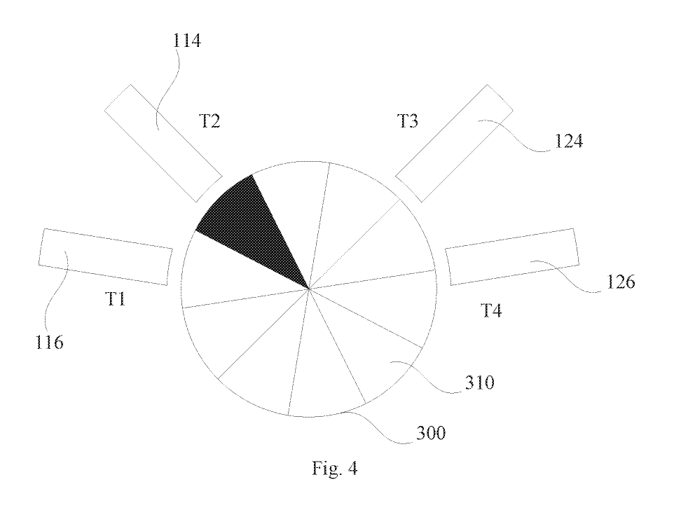

As shown in FIG. 4, the control circuit magnetically polarizes the first coil 210, turning the magnetic pole end of the first auxiliary driving pole 116 (T1) into the north pole (N) and the magnetic pole end of the first main driving pole 114 (T2) into the south pole (S), and the magnetic pole ends of the second main driving pole 124 (T3) and the second auxiliary driving pole 126 (T4) are not magnetically polarized. Therefore, the first auxiliary driving pole 116 (T1) attracts the south pole which the rotator 300 is most adjacent to, and the first main driving pole 114 (T2) attracts the north pole which the rotator 300 is most adjacent to.

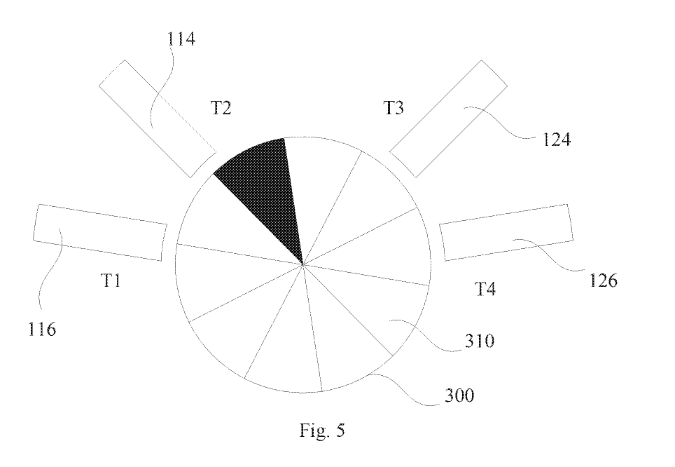

As shown in FIG. 5, the control circuit magnetically polarizes the second coil 220, turning the magnetic pole end of the second main driving pole 124 (T3) into the south pole (S) and the magnetic pole end of the second auxiliary driving pole 126 (T4) into the north pole (N), and the magnetic pole ends of the first main driving pole 114 (T2) and the first auxiliary driving pole 116 (T1) are not magnetically polarized. Therefore, the second main driving pole 124 (T3) attracts the north pole which the rotator 300 is most adjacent to, and the second auxiliary driving pole 126 (T4) attracts the south pole which the rotator 300 is most adjacent to, making the rotator 300 rotate with 18°.

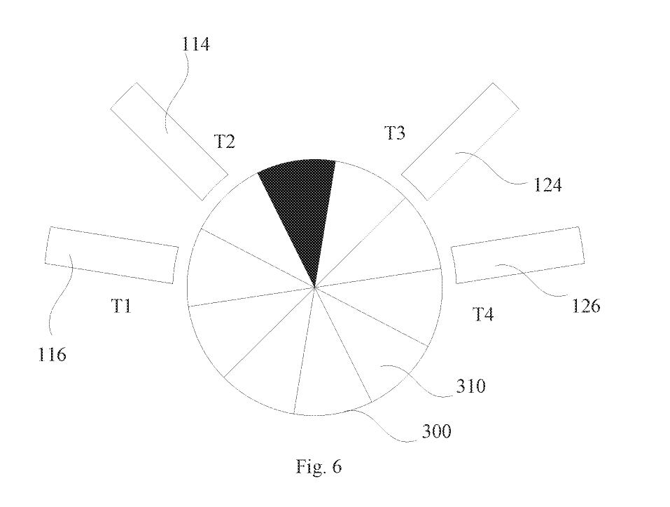

As shown in FIG. 6, the control circuit magnetically polarizes the first coil 210, turning the magnetic pole end of the first auxiliary driving pole 116 (T1) into the south pole (S) and the magnetic pole end of the first main driving pole 114 (T2) into the north pole (N), and the magnetic pole ends of the second main driving pole 124 (T3) and the second auxiliary driving pole 126 (T4) are not magnetically polarized. Therefore, the first auxiliary driving pole 116 (T1) attracts the north pole which the rotator 300 is most adjacent to, and the first main driving pole 114 (T2) attracts the south pole which the rotator 300 is most adjacent to, making the rotator 300 rotate with 18°.

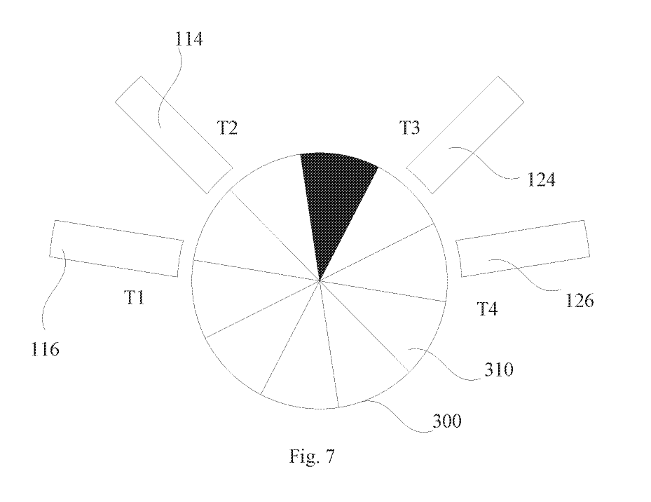

As shown in FIG. 7, the control circuit magnetically polarizes the second coil 220, turning the magnetic pole end of the second main driving pole 124 (T3) into the north pole (N) and the magnetic pole end of the second auxiliary driving pole 126 (T4) into the south pole (S), and the magnetic pole ends of the first main driving pole 114 (T2) and the first auxiliary driving pole 116 (T1) are not magnetically polarized. Therefore, the second main driving pole 124 (T3) attracts the south pole which the rotator 300 is most adjacent to, and the second auxiliary driving pole 126 (T4) attracts the north pole which the rotator 300 is most adjacent to, making the rotator 300 rotate with 18°.

The control circuit repeats the phrases of FIGS. 4 to 7 in accordance with steps, changes the magnetic polarization of the two coils sequentially and promotes the rotator 300 to rotate with a stepping of 18°. The motor becomes a stepping motor of 18°.

The above embodiments only present several embodiments of the present invention, the description of which is more specific and detailed. However, it cannot be understood as a limitation of the scope of the present invention. It should be indicated that for those skilled in the art, a variety of modifications and changes may be made without departing from the idea of the present invention. Therefore, the scope of the present invention is intended to be defined by the appended claims.

What is claimed is:

1. A stator of a stepping motor, comprising:
a first magnetic field closed loop comprising a first main body, a first main driving pole, and a first auxiliary driving pole, wherein the first main driving pole and the first auxiliary driving pole are spaced on the same side of the first body, the first main driving pole and the first auxiliary driving pole are configured to assemble a coil of the stepping motor; and
a second magnetic field closed loop comprising a second main body, a second main driving pole, and a second auxiliary driving pole, wherein the second main driving pole and the second auxiliary driving pole are spaced on the same side of the second body, the second main driving pole and the second auxiliary driving pole are configured to assemble the coil of the stepping motor;
wherein the first main driving pole is adjacent to the second main driving pole, and the first main driving pole and the second main driving pole are spaced, the first auxiliary driving pole and the second auxiliary driving pole are spaced;
wherein the first main driving pole, the first auxiliary driving pole, the second main driving pole, and the second auxiliary driving pole cooperatively enclose to form a receiving hole for receiving a rotator of the stepping motor; and
wherein an open space is formed between one end of the first body adjacent to the first auxiliary driving pole and one end of the second body adjacent to the second auxiliary driving pole and/or between one end of the first body adjacent to the first main driving pole and one end of the second body adjacent to the second main driving pole.

2. The stator of the stepping motor of claim 1, wherein the shapes and sizes of the first main driving pole, the first auxiliary driving pole, the second main driving pole, and the second auxiliary driving pole are the same.

3. The stator of the stepping motor of claim 1, wherein the first main driving pole and the second main driving pole are vertically disposed, an angle formed by one side of the first main driving pole away from the first auxiliary driving pole and one side of the first auxiliary driving pole away from the first main driving pole is 36°, an angle formed by one side of the second main driving pole away from the second auxiliary driving pole and one side of the second auxiliary driving pole away from the second main driving pole is 36°.

4. The stator of the stepping motor of claim 1, further comprising a connector, wherein both ends of the connector are respectively connected to the end of the first body adjacent to the first main driving pole and the end of the second body adjacent to the second main driving pole; wherein the open space is formed between the end of the first body adjacent to the first auxiliary driving pole and the end of the second body adjacent to the second auxiliary driving pole.

5. The stator of the stepping motor of claim 4, wherein the first main driving pole and the first auxiliary driving pole are respectively located at both ends of the first body, the second main driving pole and the second auxiliary driving pole are respectively located at both ends of the second body, and the first main driving pole is located between the first body and the connector, the second main driving pole is located between the second body and the connector.

6. A stepping motor, comprising:
a stator comprising:
a first magnetic field closed loop comprising a first main body, a first main driving pole, and a first auxiliary driving pole, wherein the first main driving pole and the first auxiliary driving pole are spaced on the same side of the first body, the first main driving pole and the first auxiliary driving pole are configured to assemble a coil of the stepping motor; and
a second magnetic field closed loop comprising a second main body, a second main driving pole, and a second auxiliary driving pole, wherein the second main driving pole and the second auxiliary driving pole are spaced on the same side of the second body, the second main driving pole and the second auxiliary driving pole are configured to assemble the coil of the stepping motor;
wherein the first main driving pole is adjacent to the second main driving pole, and the first main driving pole and the second main driving pole are spaced, the first auxiliary driving pole and the second auxiliary driving pole are spaced;
wherein the first main driving pole, the first auxiliary driving pole, the second main driving pole, and the second auxiliary driving pole cooperatively enclose to form a receiving hole for receiving a rotator of the stepping motor;
wherein an open space is formed between one end of the first body adjacent to the first auxiliary driving pole and one end of the second body adjacent to the second auxiliary driving pole and/or between one end of the first body adjacent to the first main driving pole and one end of the second body adjacent to the second main driving pole; and
wherein the rotator is respectively spaced from the first main driving pole, the first auxiliary driving pole, the second main driving pole, and the second auxiliary driving pole.

7. The stepping motor of claim 6, wherein the end faces of one ends of the first main driving pole, the first auxiliary driving pole, the second main driving pole, and the second auxiliary driving pole adjacent to the rotator are arc faces; and the end faces of one ends of the first main driving pole, the first auxiliary driving pole, the second main driving pole, and the second auxiliary driving pole adjacent to the rotator are different parts of a first circle; a center of the first circle coincides with a center of the rotator; a distance between the first circle and the rotator is d, a space outward from an outer wall of the rotator is a functional space, the areas on which the functional space and the rotator are located constitute an effective drive area together, a distance between a boundary of the functional space away from the rotator and the outer wall of the rotator is at least 5 d.

8. The stepping motor of claim 7, further comprising a connector, both ends of the connector are respectively connected with the one end of the first body adjacent to the first main driving pole and the one end of the second body adjacent to the second main driving pole; the open space is formed between the one end of the first body adjacent to the first auxiliary driving pole and the one end of the second body adjacent to the second auxiliary driving pole; one ends of the first main driving pole, the first auxiliary driving pole, the second main driving pole, and the second auxiliary driving pole away from the rotator and the connector are all located outside of the effective drive area.

9. The stepping motor of claim 6, further comprising a first coil and a second coil, wherein the first coil is sleeved on the first main driving pole or the first auxiliary driving pole, the second coil is sleeved on the second main driving pole or the second auxiliary driving pole.

10. The stepping motor of claim 9, wherein the first coil and the second coil are respectively sleeved on the first main driving pole and the second main driving pole.
